(19) United States
(12) Patent Application Publication
(10) Pub. No.: US 2013/0021247 A1
(43) Pub. Date: Jan. 24, 2013

(54) FOLDABLE WIRELESS MOUSE AND LAPTOP COMPUTER HAVING SAME

(71) Applicants: HONG-LIANG PU, Shenzhen City (CN); YONG-FENG ZHAO, Shenzhen City (CN); FU LIAO, Shenzhen City (CN); YONG-JUN GU, Shenzhen City (CN); REN-QIAN LIU, Shenzhen City (CN); MING-CHANG LEE, Tu-Cheng (TW)

(72) Inventors: HONG-LIANG PU, Shenzhen City (CN); YONG-FENG ZHAO, Shenzhen City (CN); FU LIAO, Shenzhen City (CN); YONG-JUN GU, Shenzhen City (CN); REN-QIAN LIU, Shenzhen City (CN); MING-CHANG LEE, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/434,865

(22) Filed: Mar. 30, 2012

(30) Foreign Application Priority Data
Jul. 18, 2011 (CN) 201110200496.3

(51) Int. Cl. G06F 3/033

(52) U.S. Cl. 345/163

(57) ABSTRACT

A foldable wireless mouse includes an operation part and a support part. The operation part includes an operation surface, a first matching surface and a first bottom surface. An input component is mounted on the operation surface. The first matching surface is perpendicular to the first bottom surface. The support part is rotatably connected to the operation part. The support part includes a support surface, a second matching surface, and a second bottom surface. The second matching surface is perpendicular to the second bottom surface. The operation part and the support part are able to rotate to an open state at which the operation surface is coplanar with the support surface, or to a closed state at which the first matching surface contacts with the second matching surface. A laptop computer including the foldable wireless mouse is also provided.

### BACKGROUND

1. Technical Field

The present disclosure relates to tracking devices, particularly to a foldable wireless mouse and a laptop computer having the wireless mouse.

2. Description of Related Art

Many wireless mice are not integrated in a computer. Thus, when taking the computer outside, there needs extra space to receive the wireless mouse. It is inconvenient.

What is needed, therefore, is a wireless mouse and a laptop computer which could overcome the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a foldable wireless mouse according to an embodiment, the foldable wireless mouse being in an open state.

FIG. 2 is similar to FIG. 1, but showing the foldable wireless mouse in a closed state.

FIG. 3 is a laptop computer according to an embodiment, the laptop computer including a main body and a display.

FIG. 4 is an exploded view of the main body of FIG. 3.

FIG. 5 is an enlarged view of a circled part V of FIG. 4, including an elastic connecting piece.

FIG. 6 is similar to FIG. 5, but with the elastic connecting piece removed.

FIG. 7 is a schematic, isometric view of the main body of FIG. 3.

FIG. 8 is another exploded view of the main body of FIG. 3.

### DETAILED DESCRIPTION

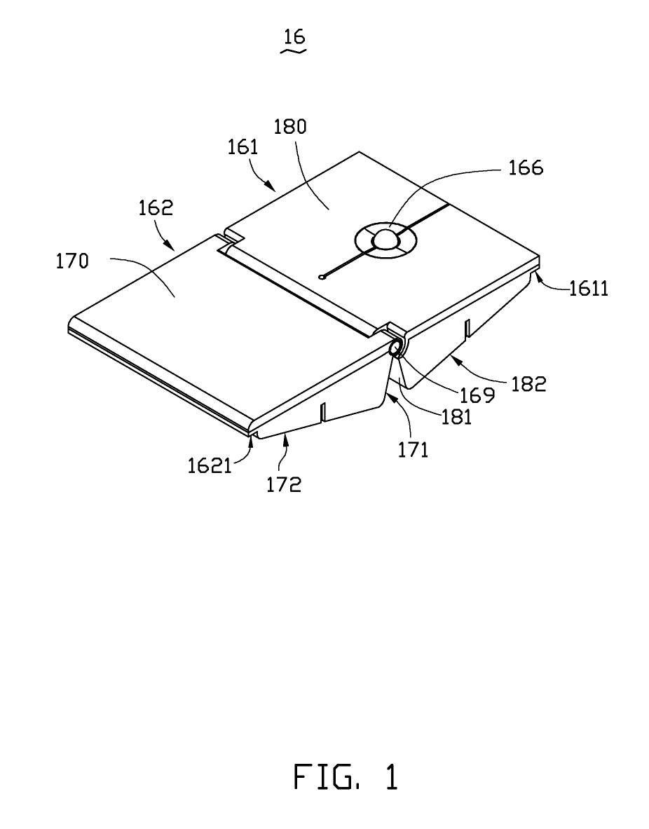

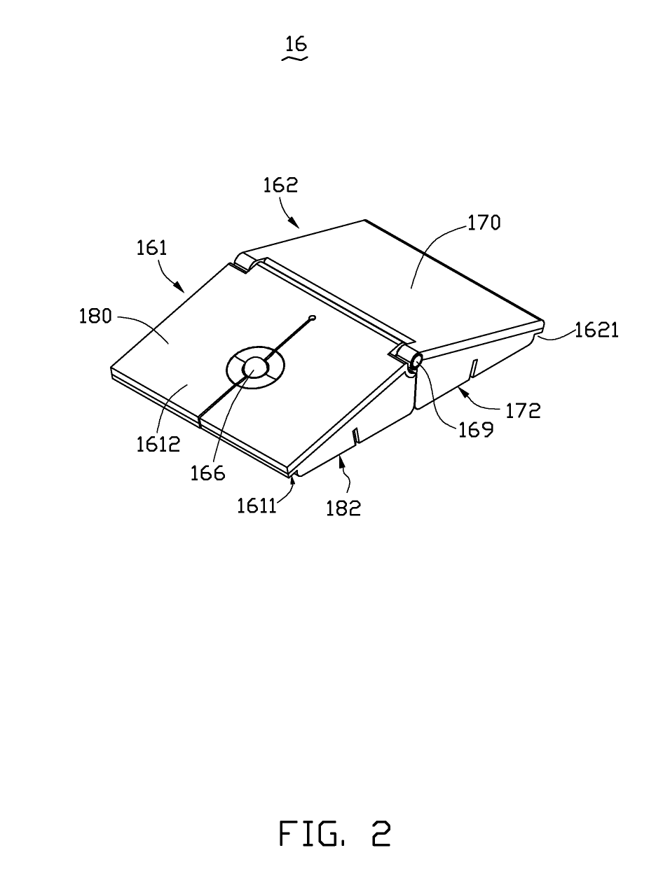

Referring to FIGS. 1 and 2, a foldable wireless mouse 16 according to an embodiment includes an operation part 161 and a support part 162.

The operation part 161 is wedge-shaped and includes an operation surface 180, a first matching surface 181, and a first bottom surface 182. The first matching surface 181 is substantially perpendicular to the first bottom surface 182. The operation surface 180 is connected between the first matching surface 181 and the first bottom surface 182. A first step 1611 is formed on the first bottom surface 182 adjacent to the operation surface 180. Input components, such as a key array 1612 and a tracing ball 166 are mounted on the operation surface 180. The key array 1612 includes a left key and a right key. The tracing ball 166 is positioned at a central part of the key array 1612.

The support part 162 is wedge shaped and includes a support surface 170, a second matching surface 171, and a second bottom surface 172. The second matching surface 171 is substantially perpendicular to the second bottom surface 172. The support surface 170 is connected between the second matching surface 171 and the second bottom surface 172. A second step 1621 is formed on the second bottom surface 172 adjacent to the support surface 170. The support surface 170 may be used to support a user's palm when the foldable wireless mouse 16 is in use.

The operation part 161 is rotatably connected to the support part 162 by a pin 169. In this way, the operation part 161 and the support part 162 can rotate around the pin 169 to an open state as shown in FIG. 1, or to a closed state as shown in FIG. 2. In the open state, the first matching surface 181 and the second matching surface 171 are substantially apart from each other, and the operation surface 180 is coplanar with the support surface 170. In the closed state, the first matching surface 181 contacts the second matching surface 171, and the first bottom surface 182 is coplanar with the second bottom surface 172. When in the closed state, the foldable wireless mouse 16 can be put on a surface and be used as an input device.

The foldable wireless mouse 16 further includes a wireless communication module (not shown), such as a BLUETOOTH module.

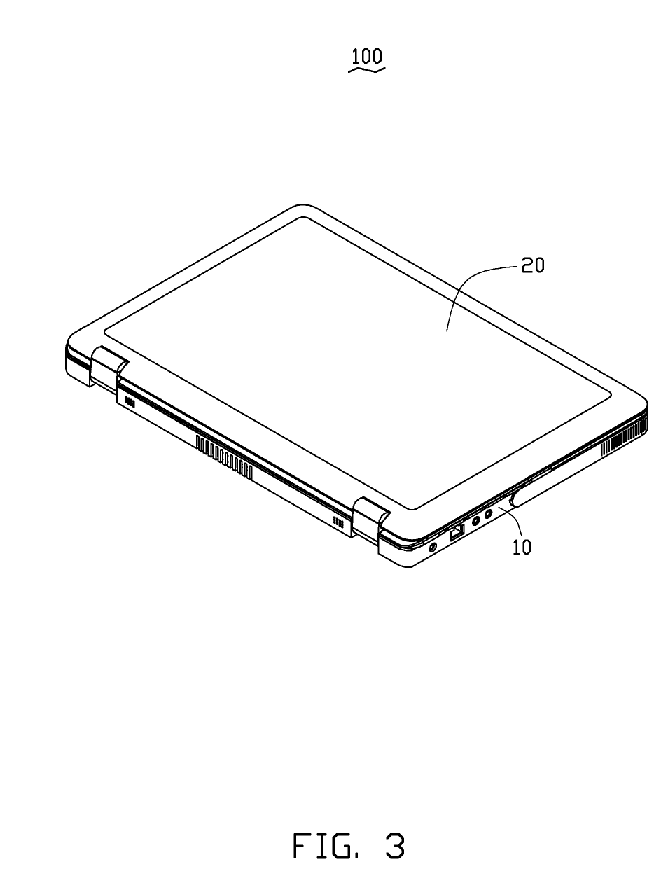

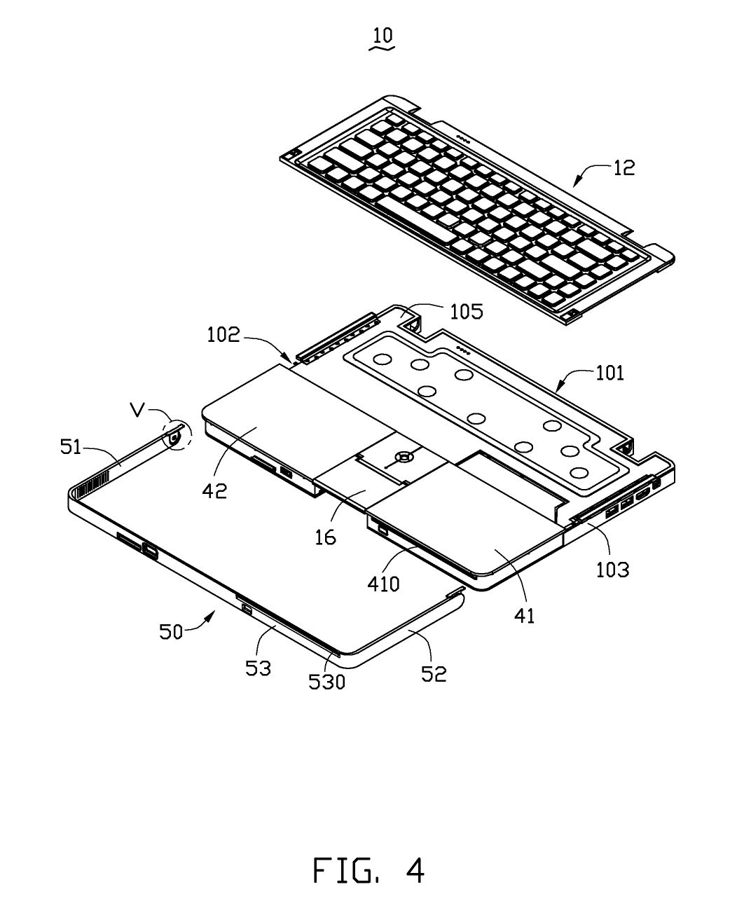

Referring to FIGS. 3 and 4, the foldable wireless mouse 16 is detachably mounted on a laptop computer 100. The laptop computer 100 includes a main body 10 and a display 20. The main body 10 includes a front end 101, a left side surface 102, a right side surface 103, and a back end 104. The display 20 is pivoted to the main body 10 at the front end 101.

The laptop computer 100 further includes an optical disk drive 41, a graphics card 42, and the foldable wireless mouse 16. The optical disk drive 41, the graphics card 42, and the foldable wireless mouse 16 are detachably mounted on the back end 104.

The main body 10 further includes a top surface 105. A keyboard 12 is mounted on the top surface 105.

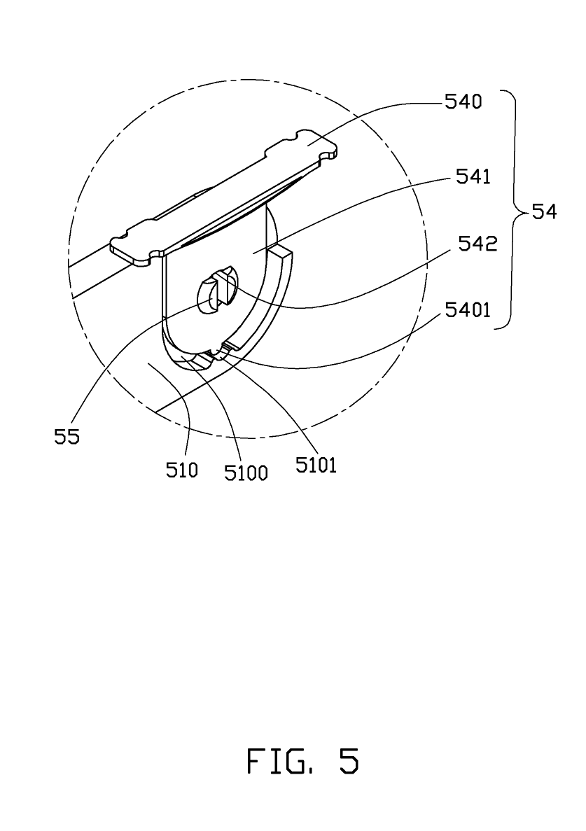

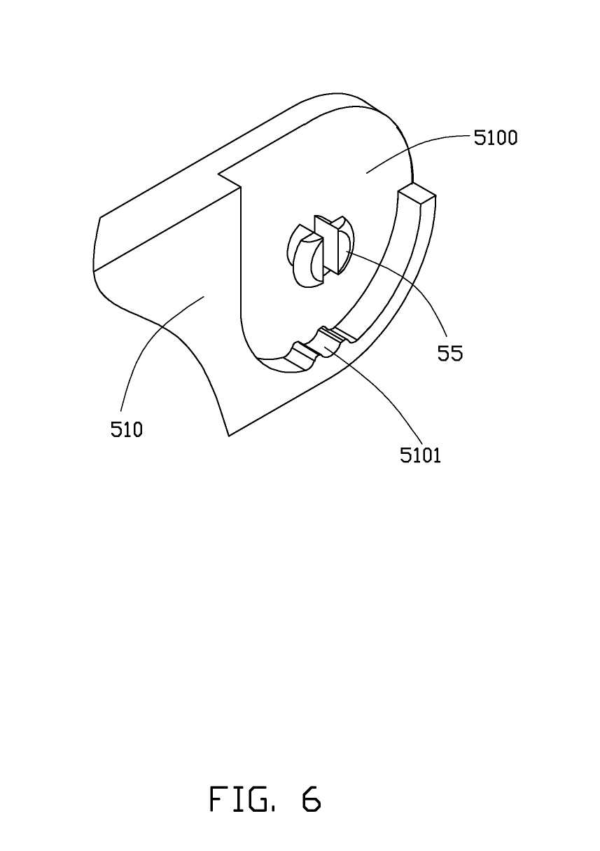

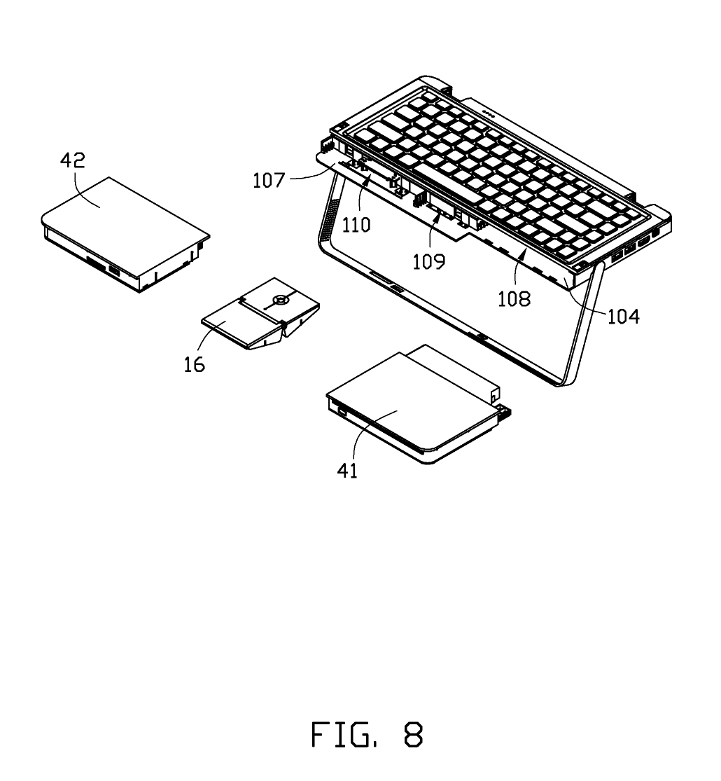

Referring to FIGS. 4-8, the laptop computer 100 further includes a frame 50. The frame 50 includes a first side strip 51, a second side strip 52 opposite to the first side strip 51, and a connecting strip 53 substantially perpendicularly connected to the first and second side strips 51, 52.

The first side strip 51 is similar to the second side strip 52 in structure. The first side strip 51 includes an end 510. The end 510 defines a depression 5100. The depression 5100 is substantially U-shaped and includes a projected part defining a locking groove 5101. The main body 10 further includes two elastic connecting pieces 54. Each elastic connecting piece 54 includes a fixing part 540 mounted on the top surface 105 of the main body 10, and a U-shaped part 541 extending from the fixing part 540 and received in the depression 5100. A pair of spaced shafts 55 fixed on the end 510 extend towards each other through a hole 542 defined in the U-shaped part 541, to rotatably connect the end 510 to the connecting piece 54. The distal ends of the shafts 55 terminate in two deformable latches arranged back-to-back which re-expand after insertion to resist on the U-shaped part 541, for keeping the connecting piece 54 and the end 510 together. The U-shaped part 541 includes a locking projection 5401 corresponding to the locking groove 5101. The second side strip 52 is connected to the right side surface 103 by means similar to the way the first side strip 51 is connected to the left side surface 102. The frame 50 is rotatable around the pair of shafts 55. The frame 50 is also movable along the extending direction of the first side strip 51 in a limited range by pulling the frame 50 and deforming the spaced shafts 55. The locking projection 5401 engages with the locking groove 5101, for keeping the frame 50 at a locked position where the first side strip 51 overlaps with the left side surface 102 when no rotation force is applied to the frame 50, as shown in FIG. 3.

A base board 107 extends from the back end 104. A first socket 108, a second socket 109, and a third socket 110 are respectively mounted on the base board 107. The optical disk drive 41, the foldable wireless mouse 16 at the open state, and the graphics card 42 are respectively inserted into the first socket 108, the second socket 109, and the third socket 110 for mechanically and electrically being connected to the main body 10. The first step 1611 is clipped between the top surface 105 and the keyboard 12. When at the locked position, the frame 50 resists on the second step 1621 to maintain the connection between the foldable wireless mouse 16 and the main body 10.

The optical disk drive 41 and the graphics card 42 engage with the frame 50 by similar means.

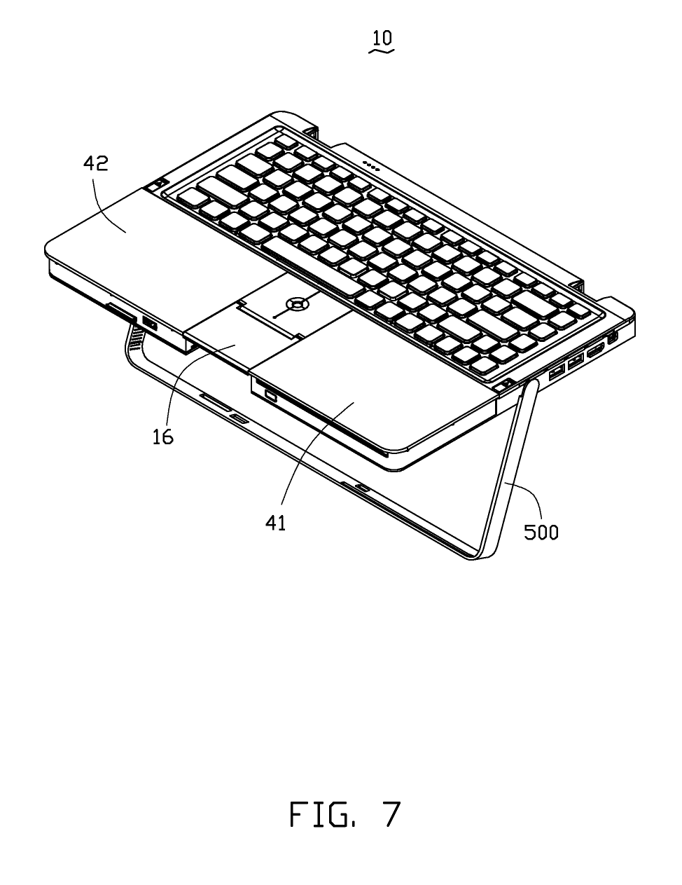

To disassemble, the frame 50 is pulled and then rotated to an unlocked position as shown in FIG. 7, and the optical disk drive 41, the foldable wireless mouse 16, and the graphics card 42 can easily be disengaged from the main body 10.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A foldable wireless mouse, comprising:
an operation part comprising an operation surface, a first matching surface and a first bottom surface, the first matching surface being substantially perpendicular to the first bottom surface;
an input component mounted on the operation surface; and
a support part rotatably connected to the operation part, the support part comprising a support surface, a second matching surface, and a second bottom surface, the second matching surface being substantially perpendicular to the second bottom surface; wherein
the operation part and the support part is able to rotate to an open state at which the operation surface is coplanar with the support surface and the first matching surface is spaced apart from the second matching surface, or to a closed state at which the first matching surface contacts with the second matching surface.

2. The foldable wireless mouse of claim 1, wherein the input component is a key array comprising a left key and a right key.

3. The foldable wireless mouse of claim 1, wherein the input component is a tracing ball.

4. The foldable wireless mouse of claim 1, wherein the operation part and the support part are wedge shaped.

5. The foldable wireless mouse of claim 1, wherein the first bottom surface and the second bottom surface are coplanar with each other at the closed state.

6. The foldable wireless mouse of claim 1, wherein the operation part comprises a first step positioned on the first bottom surface adjacent to the operation surface.

7. The foldable wireless mouse of claim 1, wherein the support part comprises a second step positioned on the second bottom surface adjacent to the support surface.

8. A laptop computer, comprising:
a main body comprising a front end, a back end opposite to the front end, a left side surface and a right side surface, both the left and right side surfaces being connected between the front end and the back end, the main body comprising a socket positioned at the back end;
a display pivoted on the front end of the main body;
a foldable wireless mouse detachably inserted into the socket, the foldable wireless mouse comprising:
an operation part comprising an operation surface, a first matching surface and a first bottom surface, the first matching surface being substantially perpendicular to the first bottom surface;
an input component mounted on the operation surface; and
a support part rotatably connected to the operation part, the support part comprising a support surface, a second matching surface, and a second bottom surface, the second matching surface being substantially perpendicular to the second bottom surface; wherein
the operation part and the support part is able to rotate to an open state at which the operation surface is coplanar with the support surface and the first matching surface is spaced apart from the second matching surface, or to a closed state at which the first matching surface contacts with the second matching surface; and
a frame movably connected to the left side surface and the right side surface respectively, wherein the frame is able to rotate between a locked position and an unlocked position, when the frame is at the locked position, the frame keeps the foldable wireless mouse in the socket, and when the frame is at the unlocked position, the frame is away from the foldable wireless mouse and the foldable wireless mouse is able to be pulled out from the socket.

9. The laptop computer of claim 8, wherein the input component is a key array comprising a left key and a right key.

10. The laptop computer of claim 8, wherein the input component is a tracing ball.

11. The laptop computer of claim 8, wherein the operation part and the support part are wedge shaped.

12. The laptop computer of claim 8, wherein the first bottom surface and the second bottom surface are coplanar when at the closed state.

13. The laptop computer of claim 8, wherein the operation part comprises a first step positioned on the first bottom surface adjacent to the operation surface.

14. The laptop computer of claim 8, wherein the operation part comprises a second step positioned on the second bottom surface adjacent to the support surface, the second step is engaged with the frame at the locked position.

15. The laptop computer of claim 8, wherein the main body further comprises a base board extending from the back end and the socket is mounted on the base board.

16. The laptop computer of claim 8, wherein the frame comprises two side strips connected to the left side surface and the right side surface respectively and a connecting strip connected between the two side strips.

17. The laptop computer of claim 16, wherein each side strip further comprises a pair of spaced shafts, the laptop computer further comprises two elastic connecting pieces fixed on the left side surface and the right side surface respectively, each elastic connecting piece defines a hole, the pair of spaced shaft extends through the hole.

18. The laptop computer of claim 17, wherein each side strip defines a locking groove, each elastic connecting piece comprises a locking projection engaging with the locking groove.

19. The laptop computer of claim 18, wherein each side strip comprises a distal end, the distal end defines a substantially U-shaped depression facing a respective one of the left side surface and the right side surface, and the depression communicates with the locking groove; each elastic connecting piece comprises a fixing part mounted on the main body and a U-shaped part extending from the fixing part, the U-shaped part is received in the depression, and the locking projection is positioned on the U-shaped part.

20. The laptop computer of claim 19, wherein the pair of spaced shafts is positioned on the distal end of each side strip and extends from a bottom surface of the depression towards a respective one of the left side surface and the right side surface, the distal ends of the pair of spaced shafts terminate in two latches which are arranged back-to-back and pass through the hole.
